(19) United States
(12) Patent Application Publication
(10) Pub. No.: US 2005/0238271 A1
(43) Pub. Date: Oct. 27, 2005

(54) Bearing assembly of a crop conveying and/or crop processing element for a harvesting machine

(76) Inventors: Rainer Schafer, Zweibrucken (DE); Claus-Josef Vogelgesang, Mandelbachtal (DE); Manfred Engel, Grosssteinhausen (DE)

Correspondence Address: Jimmie R. Oaks & W. Michael Dixon;Patent Department, DEERE & COMPANY, One John Deere Place, Moline, IL, 61265-8098, US

(21) Appl. No.: 11/110,471

(22) Filed: Apr. 20, 2005

(30) Foreign Application Priority Data
Apr. 23, 2004 (DE) 10 2004 019 816.0

(51) Int. Cl. F16C 19/50; F16C 13/00

(52) U.S. Cl. 384/460

(57) ABSTRACT

A bearing assembly of a crop conveying and/or crop processing element for a harvesting machine includes a rolling contact bearing, a stationary disk spaced axially away from the rolling contact bearing and an impeller disk rotating with the crop conveying and/or crop processing element. The stationary disk is positioned between the rolling contact bearing and the impeller disk such that interaction of the stationary disk with the impeller disk prevents intrusion of undesirable material.

### FIELD OF THE INVENTION

The present invention relates to a bearing assembly of a crop conveying and/or crop processing element for a harvesting machine. More specifically, the present invention relates to a bearing assembly of a crop conveying and/or crop processing element including a seal that protects the bearing assembly against the intrusion of undesirable material, particularly the intrusion of plant juices.

### BACKGROUND OF THE INVENTION

Prior patents, such as DE 101 15 331, describe bearing assemblies wherein the rotating shaft of a crop processing assembly is supported by a rolling contact bearing on the frame of a harvesting machine. A first stationary disk, operating as a seal, is connected to the frame of the harvesting machine, and forms a relatively narrow gap with the shaft. A second disk also operates as a seal and rotates with the shaft. The second disk is located between the first disk and the rolling contact bearing. The rolling contact bearing is protected against the intrusion of foreign matter, particularly plant juices, by means of the disks and a seal with flexible lips that are in contact with a ball race of the rolling contact bearing rotating with the shaft.

The second rotating disk operates as an impeller disk and conveys any possibly existing plant juices to the outside by means of centrifugal force. The disadvantage of this assembly lies in the fact that solid matter and fluids that have reached the intervening space, or the antechamber that is formed between the first and second disk, can no longer leave this space. They are thrown permanently to the outer, closed circumference of the antechamber by the second disk. Due to this accumulation of contaminants in the antechamber, the contaminants will eventually overcome the flexible lips of the seal and reach the rolling contact bearing itself. One proposed solution is to place outlet openings at the outer circumference of the antechamber. These have proved to be ineffective, since these openings become clogged after a short time by the contaminants.

Therefore, there is a need for an improved bearing assembly of a crop conveying and/or crop processing element of a harvesting machine that prevents penetration of plant juices into the rolling contact bearing itself.

### SUMMARY OF THE INVENTION

This problem is solved according to the teachings of the present invention wherein a stationary disk is arranged between an impeller disk and a rolling contact bearing, such that the impeller disk is in a position to deliver any possible contaminants to the outside. In this way undesirable accumulations of contaminants, particularly plant juices, on the inner side of the impeller disk are avoided.

In one aspect, the impeller disk is arranged in close proximity to the stationary disk so that only a relatively narrow gap remains between the two disks. The result is a ring-shaped radial seal. In order to improve the delivery capacity of the impeller disk, an outer region of the stationary disk is positioned adjacent the outer edge of the impeller disk. This outer region is spaced at a distance from the impeller disk that is larger than the distance between the inner region of the stationary disk and the impeller disk. The stationary disk is bent or angled between the inner and the outer regions to prevent fluids from adhering to the stationary disk due to surface tension and the like.

In another aspect, a separate seal is placed between the impeller disk and the stationary disk to improve the sealing therebetween. The seal consists of an inherently elastic material, for example, plastic or rubber, is in contact with the impeller disk by means of a surface or a pointed ridge, and is fastened to the stationary disk. Alternatively, the seal could be fastened to the impeller disk and in contact with the stationary disk.

In still another aspect a seal acting in radial direction can be arranged between the stationary disk and an element that rotates with the crop conveying and/or crop processing element, such as a ball race attached to a shaft of the crop conveying and/or crop processing element, on which the balls of the bearing assembly also run. This seal also prevents the penetration of fluids to the inner side of the stationary disk and protects the rolling contact bearing. The seal can be fastened to the rotating element or to the stationary disk.

The device of the present invention is appropriate for all crop conveying and/or crop processing elements of self-propelled, attached, or towed harvesting machines, as well as front harvesting attachments. In particular, it can be applied to forage harvesters, with which plants are frequently harvested that exude fluids which are damaging to bearing assemblies. Therefore, the bearing assembly can be used for intake rolls, chopper drums, rolls of post-chopper reduction assemblies or conveyor assemblies (blowers).

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic side view of a harvesting machine in accordance with the teachings of the present invention;

FIG. 2 is a cross sectional view of a bearing assembly in accordance with the teachings of the present invention;

FIG. 3 is an enlarged view of a portion of an alternate embodiment of the bearing assembly;

FIG. 4 is an enlarged view of a portion of another alternate embodiment of the bearing assembly;

FIG. 5 is an enlarged view of a portion of yet another alternate embodiment of the bearing assembly; and

FIG. 6 is an enlarged view of a portion of still another alternate embodiment of the bearing assembly.

### DESCRIPTION OF THE EMBODIMENTS

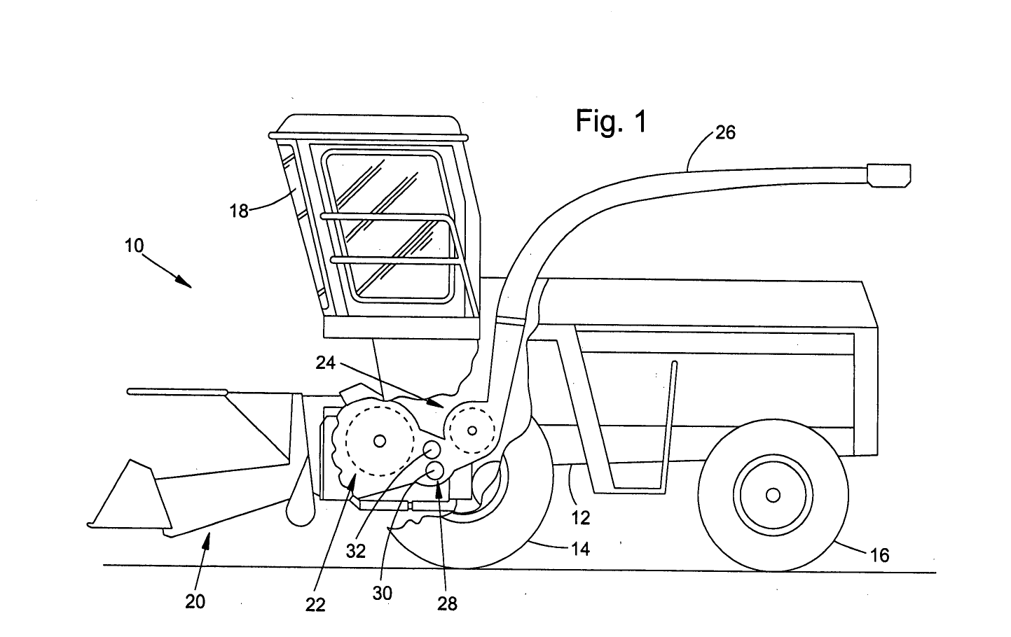

A harvesting machine 10 in the form of a self-propelled forage harvester is shown generally in FIG. 1. The harvesting machine 10 is supported on a frame 12 that is carried by front and rear wheels 14 and 16. The harvesting machine 10 is controlled from an operator's cab 18 from which a crop recovery assembly 20 in the form of a corn head can be controlled visually. Crop taken up from the ground by the crop recovery assembly 20, for example, corn, grass or the like, is conducted to a chopper drum 22 that chops it into small pieces and delivers it to a conveyor assembly 24. The crop leaves the harvesting machine 10 to an accompanying trailer through a rotating discharge duct 26. A post-chopper reduction assembly 28 extends between the chopper drum 22 and the conveyor assembly 24 such that the crop to be conveyed is conducted tangentially to the conveyor assembly 24. The post-chopper reduction assembly 28 is provided with two rolls 30, 32, that rotate in opposite directions.

A potential problem of the post-chopper reduction assembly 28 as well as the other crop conveying and/or crop processing elements of the harvesting machine 10, for example, the conveyor assembly 24 and the intake rolls (not shown), that precede the chopper drum 22, lies in the fact that plant juices are exuded during the conveying or processing of the harvested crop. These juices can penetrate the bearing assemblies of the crop conveying and/or crop processing elements and cause corrosion.

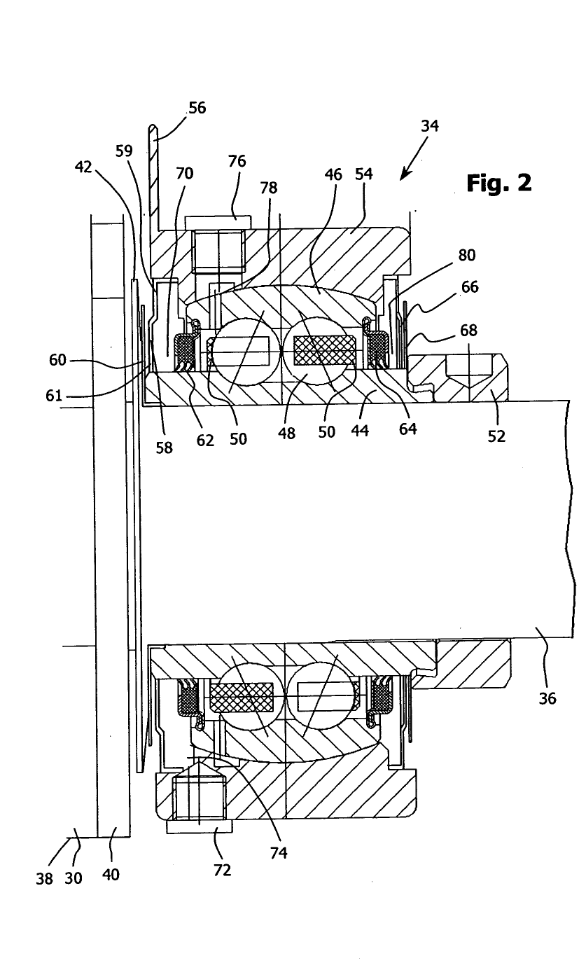

In order to prevent the intrusion of plant juices into the rolling contact bearings, the lower roll 30 of the post-chopper reduction assembly 28 is equipped with a bearing assembly 34 that is shown in greater detail in FIG. 2. The upper roll 32 can also be equipped with such a bearing assembly 34.

Referring to FIG. 2, the roll 30 is provided with a sleeve 38. A support disk 40 is inserted into the end of the sleeve 38. The support disk 40 carries a stub shaft 36. A protective disk 42 is positioned between the support disk 40 and the bearing assembly 34, it is applied to the stub shaft 36 and is intended to protect the bearing assembly 34 against plant juices. The bearing assembly 34 is provided with an inner ball race 44 mounted onto the stub shaft 36 and an outer ball race 46, that encloses the inner ball race 44. A row of balls 48 is arranged between the inner ball race 44 and the outer ball race 46 as rolling contact bearings. They are retained by cages 50, and roll in corresponding, rounded tracks in the ball races 44, 46. Two rows of balls 48 are positioned behind each other in the axial direction. The inner ball race 44 is fastened to the stub shaft 36 by a clamping disk 52. The clamping disk 52 or part of the stub shaft 36 projecting beyond the clamping disk 52 can also be used to fasten a belt pulley or another drive means. The outer ball race 46 is enclosed radially by a bearing housing 54 that is fastened to a side wall 56 of the crop conveying channel of the harvesting machine 10.

A stationary disk 58 is positioned between the bearing housing 54 and the inner ball race 44. The stationary disk 58 is generally ring shaped and is connected to the bearing housing 54 and extends radially inward almost to the inner ball race 44. A narrow gap remains between the inner edge of the stationary disk 58 and the ball race 44. An impeller disk 60 in the form of a flat and level ring extends from the inner ball race 44 and is positioned axially further outward from the balls 48 than the stationary disk 58. The stationary disk 58 includes a bend in the region of its middle at a location radially inward from the outer edge of the impeller disk 60. The stationary disk is bent outward in the direction of the impeller disk 60. Thereby it is provided with a flat radial inner region 61 that is adjacent to the impeller disk 60, and a flat radially outer region 59 that is spaced further away from the impeller disk 60 in the axial direction, as compared to the inner region 61.

The stationary disk 58 and the impeller disk 60 form a labyrinth seal by means of their immediately adjacent surfaces (region 61). The impeller disk 60 rotates with the stub shaft 36, while the stationary disk 58 does not rotate. Any possible material intruding into the space between the impeller disk 60 and the stationary disk 58, such as plant juices, is brought into rotation by the impeller disk 60 and accelerated outward by centrifugal force. These intruding materials leave the impeller disk 60 at that disks outer edge aided by the greater spacing at that point from the outer region 59 of the stationary disk 58. This prevents trouble-prone quantities of the material from reaching an antechamber 70 between the stationary disk 58 and the region of the ball race 44 that adjoins it radially inward.

A seal 62 is provided with flexible lips that are in contact with the inner ball race 44. The seal 62 is spaced at a greater distance from the roll 30 than the stationary disk 58 and is connected to the outer ball race 46. The seal 62 also prevents plant juices from reaching the balls 48.

A second seal 64, a second stationary disk 66 and a second impeller disk 68 are positioned on the outer side of the bearing assembly 34. The second seal 64, second stationary disk 66, and second impeller disk 68 are generally symmetrical to the first seal 62, the first stationary disk 58 and the first impeller disk 60 and operate analogously.

The antechamber 70 is a hollow chamber positioned between the first stationary disk 58 and the first seal 62. The antechamber 70 is supplied with grease through a first grease supply 72 over a first channel 74 that penetrates radially through the bearing housing 54. The balls 48 are supplied with grease through a second grease supply 76 over the first channel 74 that penetrates radially through the bearing housing 54. An outer antechamber 80 is positioned between the second seal 64 and the second stationary disk 66. The outer antechamber 80 is also supplied with grease through the second channel 78 and the space between the balls 48 and under the outer seal 64 with flexible lips that are in sealing contact with the inner ball race 44.

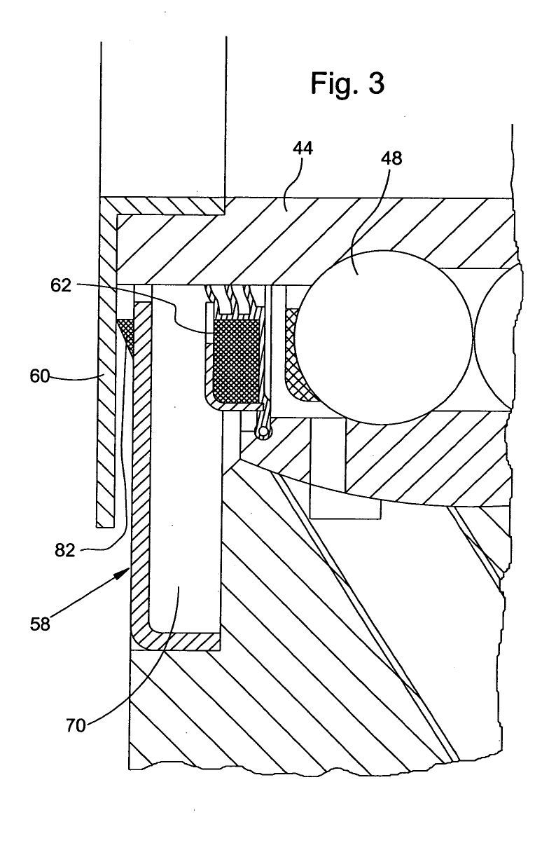

An enlarged section of a cross sectional view of an alternate embodiment of the bearing assembly is shown in FIG. 3. In order to make the penetration of plant juices and other contaminants into the antechamber 70 more difficult, a ring-shaped seal 82 with a triangular cross section of inherently elastic material is connected to the stationary disk 58. A pointed ridge of the seal is in contact with the impeller disk 60.

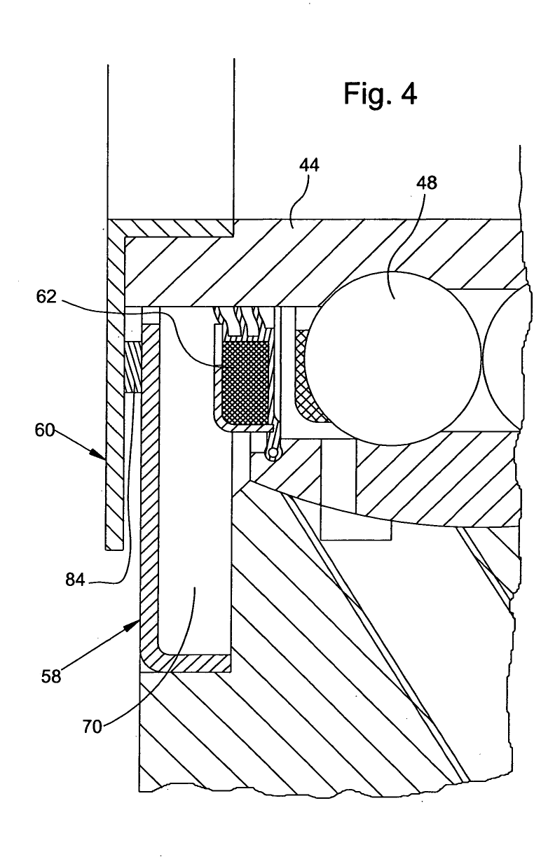

Referring to FIG. 4, in another alternate embodiement, a ring-shaped seal 84 of inherently elastic, sponge-like material with a rectangular cross section is used to seal the intervening space between the impeller disk 60 and the stationary disk 58.

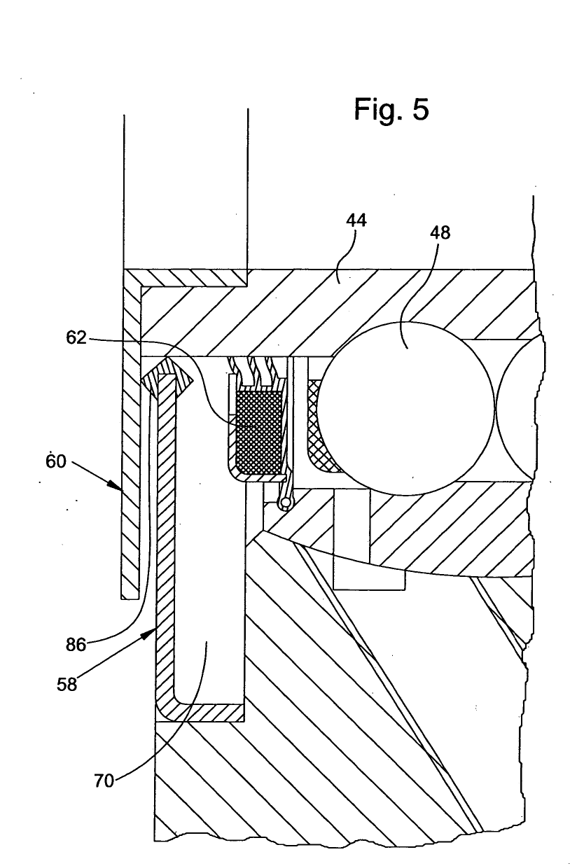

Referring to FIG. 5, in yet another alternate embodiment, a ring-shaped seal 86 is attached to the inner end of the stationary disk 58 facing the ball race 44. The cross section of the ring-shaped seal 86 is approximately trapezoidal, where a recess is provided for sliding the seal onto the stationary disk 58. The seal 86 consists of inherently elastic material, contacts the impeller disk 60 with a first pointed ridge, and contacts the ball race 44 with a second pointed ridge, thereby forming a double sealing effect, wherein better sealing performance of the seal 86 is achieved.

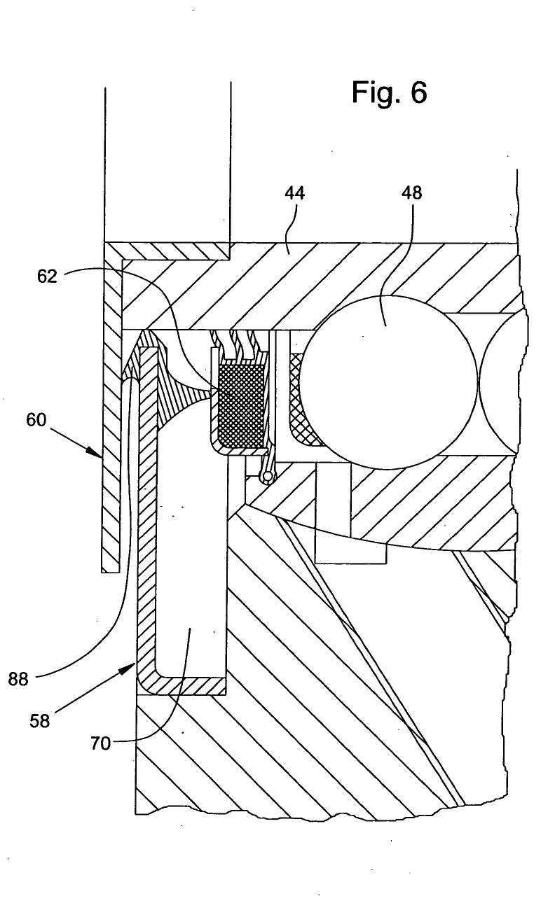

Still another alternate embodiment is shown in FIG. 6, which is similar to the embodiment shown in FIG. 5, however, the seal 88 used here is also in contact with the outer wall of the retainer of the seal 62 facing in the axial direction of the stationary disk 58.

In accordance with the provisions of the patent statutes, the present invention has been described in what is considered to represent its preferred embodiment. However, it should be noted that the invention can be practiced otherwise than as specifically illustrated and described.

1. Bearing assembly of a crop processing element for a harvesting machine comprising:
a rolling contact bearing;
an impeller disk adapted to rotate with the crop processing element; and
a stationary disk spaced axially from the rolling contact bearing and positioned axially between the rolling contact bearing and the impeller disk such that interaction of the impeller disk with the stationary disk prevents the intrusion of undesirable material, particularly from plant juices.

2. The bearing assembly according to claim 1 wherein an axial gap is defined between the stationary disk and the impeller disk.

3. The bearing assembly according to claim 2 wherein the stationary disk includes an inner region extending parallel to the impeller disk, the axial gap being defined between the inner region of the stationary disk and the impeller disk.

4. The bearing assembly according to claim 3 wherein the stationary disk includes an outer region that is axially spaced from the impeller, the outer region of the stationary disk being spaced further from the impeller than the inner region of the stationary disk.

5. The bearing assembly according to claim 4 wherein an inner end of the outer region of the stationary disk is located radially closer to an axis of rotation of the bearing assembly than an outer edge of the impeller disk.

6. The bearing assembly according to claim 1 further including a seal positioned between the stationary disk and the impeller disk.

7. The bearing assembly according to claim 6 wherein the seal is fastened to the stationary disk and includes a pointed ridge that is in contact with the impeller disk.

8. The bearing assembly according to claim 1 further including a seal extending radially between the stationary disk and a surface rotating with the crop processing element.

9. The bearing assembly according to claim 8 wherein the surface rotating with the crop processing element is a ball race.

10. The bearing assembly according to claim 1 wherein the bearing assembly is adapted to be mounted within a harvesting machine.
